(19) United States
(12) Patent Application Publication
(10) Pub. No.: US 2017/0282258 A1
(43) Pub. Date: Oct. 5, 2017

(54) CROSS HOLE DEBURRING TOOL, CROSS HOLE DEBURRING METHOD, AND ROTARY VALVE MACHINED BY USING THE SAME

(71) Applicant: KITZ CORPORATION, Chiba (JP)

(72) Inventor: Hiroki OHNO, Nagano (JP)

(21) Appl. No.: 15/518,075

(22) PCT Filed: Oct. 14, 2015
(86) PCT No.: PCT/JP2015/079001

§ 371 Date: Apr. 10, 2017

(30) Foreign Application Priority Data
Oct. 14, 2014 (JP) 2014-209637

(51) Int. Cl. B23B 51/10; B23B 51/08; E21B 10/60; B23K 26/361

(52) U.S. Cl. CPC B23B 51/101; B23K 26/361; B23B 51/08; E21B 10/602; B23B 51/00

(57) ABSTRACT

A cross hole deburring tool which performs rotary cutting on a cross hole burr occurring on a cross ridgeline part between a through path and an inner circumferential surface of a spherically-shaped hollow part. A tool main body includes a tip part and a shank, and the tip part has a shape obtained by setting a diameter axis of a circle, setting an eccentric axis parallel to the diameter axis and away therefrom by a predetermined eccentric distance, setting a closed region in a bow shape formed of a line segment obtained by cutting the eccentric axis by the circle and a minor arc on the circle by defining this line segment as a chord, setting an outer surface shape of a bow-shaped solid of revolution formed by rotating this bow shape about the eccentric axis, and taking this outer surface shape as the shape of the tip part.

### TECHNICAL FIELD

The present invention relates to, in particular, cross hole deburring tools, cross hole deburring methods, and rotary valves machined by using the same and, in particular, a cross hole deburring tool, cross hole deburring method, and rotary valve machined by using the same capable of cutting and deburring a burr occurring in a cross hole between a cylindrical-shaped through path and a curved inner surface, such as a spherical inner surface or cylindrical inner surface, of a workpiece along its cross ridgeline part into a substantially uniform surface width.

### BACKGROUND ART

When drilling machining is performed on a workpiece such as a plate material or pipe material by using a cutting tool such as a drill, a material-warping burr occurs on a cross ridgeline part between the workpiece and a machined hole over the entire periphery. If a burr remains on the cross ridgeline part, fixing, measuring, and precision machining of the workpiece may be inhibited, thereby bringing various adverse effects such as operator's injury. To remove this burr, deburring machining is performed on the cross ridgeline part after boring machining.

However, when a through hole is drilled and machined from the outside of the workpiece toward an inside hollow part, the burr occurring on the cross ridgeline part warps toward the inside of the hollow part of the workpiece. Also, when the inner circumferential surface of a hollow part of the workpiece is a curved surface such as a spherical surface or cylindrical surface, the cross ridgeline part of the through hole generally becomes a three-dimensionally distorted closed curve.

Thus, when a burr occurs on the cross ridgeline part in a complex shape formed on the hollow part of the workpiece, it is required to cause a blade edge to directly act on the cross ridgeline part inside the workpiece and move along the cross ridgeline part to remove the burr. This makes the structure, movement locus, and so forth of the blade edge complex, makes deburring machining difficult, and makes a machined surface and so forth after machining nonuniform.

In particular, when boring machining is performed on the inner circumferential surface (spherical surface part) of a body of a rotary valve as depicted in FIG. 12 from the outside to form an outflow/inflow port, the cross ridgeline part is a distorted three-dimensional oval shape, and a burr occurs over the entire periphery of the ridgeline on a seal sliding surface side. A seal member for fluid sealing opposing the output/inflow port and attached to a rotary valve body slides over the entire periphery of the outer circumferential edge of this cross ridgeline part. However, as described above, if used with the occurrence of the burr, the seal sliding surface of the seal member is impaired to decrease sealing performance. Moreover, even if the burr on this cross ridgeline part is subjected to deburring machining by a conventional deburring tool, its machined surface cannot be machined to have a uniform surface width over the entire periphery of the ridgeline. Therefore, with opening and closing of the valve body, the sliding surface of the seal member is unevenly abraded, causing a decrease of the life of the seal member. Furthermore, since the above-described nonuniform machined surface width is formed, the need for covering the entire outer periphery of the machined surface of the sealing surface with a sufficient abutment width arises. Thus, a seal member with a substantially large diameter with respect to the dimensions of the outflow/inflow port is required, an increase in size of a valve chamber for accommodating the seal member, the valve body, and so forth cannot be avoided, and product cost performance and so forth are degraded. Therefore, particularly in the rotary valve, when deburring machining is performed on the cross ridgeline part of the inner circumferential surface (spherical surface part) of the workpiece, it is required not only to remove a burr but also to finish that part with a uniform machined surface width over its entire periphery.

Conventionally, removal of this burr occurring to a cross hole on the inner circumferential surface of the hollow part is performed by mechanical machining of causing mainly a deburring-dedicated rotary tool such as a drill blade to enter the hollow part of the workpiece for cutting or by polishing machining of filing by manual operation in accordance with the shape of the cross ridgeline part.

PTL 1 to PTL 4 are prior art regarding this mechanical machining. In PTL 1, a deburring tool of cutting by putting a blade edge with an outer circumferential surface in a convex arc shape in a rotation axis direction onto a burr-formed location is disclosed. In PTL 2, a technique is disclosed in which while a tool with a spherically-shaped blade edge at its tip part is three-dimensionally moved in parallel, the blade edge is put on a burr occurring on the inner surface of the hollow part of the workpiece for chamfering. PTL 3 discloses a deburring method and so forth in which a cutter is caused to enter a through hole where a burr occurs on its outer edge part from a through hole side to the inside of the hollow of the workpiece and the burr is cut by a combination of self-rotation and revolution of the cutter while the workpiece and the cutter are being pushed.

Also, an NC machine tool is known in which a three-dimensional numerical control machining program including the shape of the workpiece, tool route, and so forth is inputted and the blade edge is automatically moved in accordance with the shape of the cross ridgeline part. For example, PTL 4 discloses a deburring method of removing a burr by making a blade in a cylindrical shape abut on a cross hole inside the workpiece as being tilted and a deburring robot system in which that method is applied to a multi-articulated robot operating with numerical control.

Furthermore, there is a means for deburring machining different from mechanical machining as described above. Also known are electric machining by electropolishing or the like by concentrating a current on a burr for elution and machining by polishing and removing a burr by pumping abrasive grain to the inside of the workpiece.

### CITATION LIST

### Patent Literatures

PTL 1: Japanese Patent Application Laid-Open Publication No. 2005-74523

PTL 2: Japanese Patent Application Laid-Open Publication No. 10-507

PTL 3: Japanese Patent Application Laid-Open Publication No. 5-208307

PTL 4: Japanese Patent Application Laid-Open Publication No. 2009-72872

### SUMMARY OF INVENTION

### Technical Problem

However, in the conventional mechanical machining as described above, there is a problem in which a burr occurring the cross ridgeline part between the inner circumferential surface, such as a spherical surface or cylindrical surface, of the hollow part on the inside of the workpiece and the through path cannot be finished by simple and reliable rotary cutting machining of rotating and putting the tip part (blade edge) in a single shape onto a machined location, as a machined surface having a uniform machined surface width over the entire periphery of that cross ridgeline part and having homogeneous surface roughness over the entire surface.

That is, in deburring machining described in PTL 1 or PTL 2, since the shape of the blade edge is a simple spherical shape, if cutting is tried over the entire periphery of the cross ridgeline part where a burr occurs to obtain a uniform width, there is a problem in which the blade edge has to be put many times in accordance with the shape of the cross ridgeline part, a plurality of blade edges has to be used depending on the purpose, or the operation of the blade and the workpiece has to be made complex. Also, in cutting by putting the blade many times, different conditions such as the contact angle, contact pressure, and so forth are required for each contact location of the cross ridgeline part. Therefore, the surface width and surface roughness of the machined surface may become nonuniform. In particular, when the inner surface of the workpiece is in a spherically-shaped hollow shape or the like, the shape of the cross ridgeline part between the inner surface and the through path is a three-dimensionally distorted shape, and the burr may not be able to be appropriately removed unless the blade edge of the deburring tool is caused to approach from the inside of the workpiece. In this case, for example, in the tool caused to enter from a through path side as disclosed in PTL 3, the surface width of the deburred surface is finished as nonuniform, and therefore the tool cannot be used depending on the use purpose.

On the other hand, if the shape of the tip part is formed by a compound curve in accordance with the shape of the cross ridgeline part, there is a problem in which the design of the blade edge becomes complex and it is difficult to manufacture a blade.

Also, since a machined surface by cutting by the NC machine tool as in PTL 4 is finished by fine movement of the blade edge under numerical control so as to be scraped off discontinuously, the surface becomes a surface with asperities with many cutting traces left thereon. These cutting traces do not depend on the curved shape to be formed, the shape and size of the blade edge, resolving power of numerical control, or the like. Thus, when the cross ridgeline part of the body of the rotary valve as depicted in FIG. 12 is subjected to deburring machining by a general NC machine tool, the machined surface after machining becomes a surface with asperities formed with surfaces radially extending from its center laminated via micro-step parts.

Moreover, in the NC machine tool, there is also a problem of an occurrence of bearing various costs, such as generation of a complex numerical control program three-dimensionally along the cross ridgeline part and preparation of special machining equipment, compared with simple mechanical cutting machining.

Moreover, other than mechanical machining as described above, deburring machining by fluid grinding or manual operation can be performed. In the case of using these means, however, there are various problems in which the dimensions of the surface width that can be deburred have a limit, finishing accuracy of the machined surface depends on its natural course to make product quality unstable, secondary and tertiary burrs tend to occur, and so forth.

Thus, the present invention was developed to solve the above-described problems, and has an object of providing a cross hole deburring tool in deburring machining for a cross hole burr occurring, when a through path is drilled in a workpiece from outside, on a cross ridgeline part between this through path and an inner circumferential surface of a hollow part inside the workpiece, the tool capable of making its machined surface as a homogeneous machined surface without asperities over its entire surface and having a substantially uniform surface width over the entire periphery of the cross ridgeline part, with a shape of a tip part (blade edge) of the deburring tool geometrically adapted to the shape of the cross ridgeline part and by putting the tip part of the tool once onto this cross ridgeline part for rotary cutting, thereby providing a rotary valve capable of significantly simplifying a process of manufacturing a tool main body and a machined product, improving mass-productivity and the like, significantly reducing manufacturing cost, and reliably maintaining sealability of a seal member over a long period of time.

### Solution to Problem

To achieve the object described above, the invention according to claim 1 is directed to a cross hole deburring tool which performs rotary cutting on a cross hole burr occurring on a cross ridgeline part between a through path and an inner circumferential surface of a spherically-shaped hollow part, with a center axis of the through path in a cylindrical shape not passing through a spherical center of the spherically-shaped hollow part in a workpiece and with the through path drilled into the spherically-shaped hollow part toward a direction passing through a diameter of the spherically-shaped hollow part, wherein a tool main body of this tool includes a tip part and a shank, and the tip part has a shape obtained by setting a diameter axis of a circle, setting an eccentric axis parallel to the diameter axis and away therefrom by a predetermined eccentric distance, setting a closed region in a bow shape formed of a line segment obtained by cutting the eccentric axis by the circle and a minor arc on the circle by defining this line segment as a chord, setting an outer surface shape of a bow-shaped solid of revolution formed by rotating this bow shape about the eccentric axis, and taking this outer surface shape as the shape of the tip part.

The invention according to claim 2 is directed to a cross hole deburring tool which performs rotary cutting on a cross hole burr occurring on a cross ridgeline part between a through path and an inner circumferential surface of a cylindrically-shaped hollow part, with the through path drilled into the cylindrically-shaped hollow part toward a direction in which a center axis of the through path in a cylindrical shape passes through a center axis of the cylindrically-shaped hollow part in a workpiece, wherein a tool main body of this tool includes a tip part and a shank, the tip part has a shape obtained by setting a diameter axis of a circle, setting an eccentric axis parallel to the diameter axis and away therefrom by a predetermined eccentric distance, setting a closed region in a bow shape formed of a line segment obtained by cutting the eccentric axis by the circle and a minor arc on the circle by defining this line segment as a chord, setting an outer surface shape of a bow-shaped solid of revolution formed by rotating this bow shape about the eccentric axis, and taking this outer surface shape as the shape of the tip part.

The invention according to claim 3 is directed to the cross hole deburring tool according to claim 1 or claim 2, wherein a groove in an appropriate shape is formed at the tip part along a rotation axis direction of the shank, and the tip part is a double-edged blade or a triple-edged blade.

The invention according to claim 4 is directed to a cross hole deburring method using the cross hole deburring tool according to any one of claim 1 to claim 3, wherein a burr occurring on the cross ridgeline part is subjected to rotary cutting by moving a position of the tip part to a predetermined position with respect to the workpiece.

The invention according to claim 5 is directed to a rotary valve obtained by drilling an outflow/inflow port in a cylindrical shape into a spherical surface part of an inner circumferential surface of a body, performing rotary cutting on a cross hole burr occurring on a cross ridgeline part between this outflow/inflow port and the inner circumferential surface of the body by the cross hole deburring tool according to any one of claim 1 to claim 3, accommodating a valve body in a hemispherical body shape in this body from an opening of the body, covering this opening with a lid member, rotatably providing the valve body in the body, forming a through port in this valve body for communication with the outflow/inflow port and attaching a seal member in a circular shape, providing the outflow/inflow port so that the outflow/inflow port can be opened and closed by rotating operation of the valve body, and maintaining sealability of the seal member attached to the valve body.

The invention according to claim 6 is directed to the rotary valve according to claim 5, wherein the rotary valve is a two-way valve, a three-way valve, or a four-way valve.

### Advantageous Effects of Invention

From the invention according to claim 1, the shape of the tip part of the cross hole deburring tool is geometrically adapted to the shape of the cross ridgeline part between the inner circumferential surface (spherical surface part) of the spherically-shaped hollow part and the through path in the workpiece. Thus, when deburring machining is performed on the cross ridgeline part by the tool, with rotary cutting by putting the tip part once, finishing can be made to obtain a homogeneous machined surface without asperities and having a substantially uniform surface width over the entire periphery of the machined surface. Also, the tool main body includes the shank and the tip part, and the shape of the tip part has a simple structure with a single shape. Therefore, it is possible to improve mass-productivity of the tool main body and reduce blade manufacturing cost.

Also, when machining is performed by the cross hole deburring tool of the present invention, at the point of intersection of the inner circumferential surface of the hollow part and the through path in the workpiece, it is possible to form a machined surface so that an angle formed by the tangent of the inner circumferential surface and the tangent of the machined surface (tangent angle) is an obtuse angle. With this, it is possible to suppress an occurrence of a secondary burr by rotary cutting by the deburring tool on the outer periphery of the machined surface after machining.

From the invention according to claim 2, the shape of the tip part of the cross hole deburring tool is geometrically adapted to the shape of the cross ridgeline part between the inner circumferential surface (cylindrical surface part) of the cylindrically-shaped hollow part and the through path in the workpiece. Thus, when deburring machining is performed on the cross ridgeline part by the tool, with rotary cutting by putting the tip part once, finishing can be made to obtain a homogeneous machined surface without asperities and having a substantially uniform surface width over the entire periphery of the machined surface. Also, the tool main body includes the shank and the tip part, and the shape of the tip part has a simple structure with a single shape. Therefore, it is possible to improve mass-productivity of the tool main body and reduce blade manufacturing cost.

Also, when machining is performed by the cross hole deburring tool of the present invention, at the point of intersection of the inner circumferential surface of the hollow part and the through path in the workpiece, it is possible to form a machined surface so that an angle formed by the tangent of the inner circumferential surface and the tangent of the machined surface (tangent angle) is an obtuse angle. With this, it is possible to suppress an occurrence of a secondary burr by rotary cutting by the deburring tool on the outer periphery of the machined surface after machining.

From the invention according to claim 3, the shape and number of cutting edges and groove parts can be adjusted in accordance with the shape of the workpiece. For example, if a groove part in an appropriate shape is formed at the tip part so that chips can be easily discharged through the groove part to the outside at the time of cutting, an adverse effect on the finished surface due to chips can be suppressed.

From the invention according to claim 4, even for a cross hole burr of the cross ridgeline part formed on the recessed-shaped spherical surface part or the cylindrical surface part and three-dimensionally distorted, complex operation control is not required, such as continuous fine adjustment of displacement and change in orientation of the tool main body, and deburring machining can be performed with simple operation of only causing the tip part to approach to be put onto the cross ridgeline part. Furthermore, finishing can be made to obtain a homogeneous machined surface without asperities and having a substantially uniform surface width over the entire periphery of the cross ridgeline part.

From the invention according to claim 5, since a burr occurring on the cross ridgeline between the outflow/inflow port and the inner circumferential surface of the body is subjected to rotary cutting by the cross hole deburring tool according to claim 1 or claim 2, its machined surface has a substantially uniform surface width over the entire periphery of its cross ridgeline part, and is homogeneous without asperities. Thus, a nonuniform contact of the seal member due to the abutment location of the sliding surface is suppressed, and deflection of abrasion of the seal member is prevented. Therefore, it is possible to maintain sealability of the seal member over a long period of time, and also avoid an increase in size of the seal member according to the dimeter of the outflow/inflow port for sealing, thereby allowing provision of a compact rotary valve.

Furthermore, in this rotary valve, by inserting the valve body in a hemispherical surface shape into this rotary valve accommodating part having a semispherical inner surface shape, the diameter of the outflow/inflow port can be made as a full-bore diameter while compact properties are ensured, and large flow rate and displacement volume when the outflow/inflow port is made communicable can be ensured. Also, by adjusting the exhaust diameter as appropriate, the exhaust time can be suppressed to be short within a predetermined time. Furthermore, since the body can be made to have a one-piece structure, loosening of components at the time of piping operation can be avoided, air leakage from the body can be reliably prevented, the component structure can be simplified, and arrangement can be made even in a narrow space.

From the invention according to claim 6, the invention can be used as appropriate for a rotary valve such as a two-way valve, three-way valve, or four-way valve.

### BRIEF DESCRIPTION OF DRAWINGS

FIG. 1(a) depicts a side surface outer shape view of one example of a cross hole deburring tool according to the present invention, FIG. 1(b) depicts a side surface outer shape view of a bow-shaped solid of revolution, and FIG. 1(c) depicts a side surface outer shape view of a spherical surface.

FIG. 2 is a conceptual diagram depicting formation of the bow-shaped solid of revolution representing the shape of a tip part of the cross hole deburring tool.

FIG. 3(a) depicts a side view depicting another example of the cross hole deburring tool according to the present invention, and FIG. 3(b) depicts a perspective view of FIG. 3(a).

FIG. 4(a) is a perspective descriptive diagram of a hemispherical-surface workpiece, and FIG. 4(b) is a partially-cutout perspective descriptive diagram depicting a state of using the cross hole deburring tool according to the present invention for the hemispherical workpiece of FIG. 4(a).

FIG. 5 is a descriptive diagram of a B-B section in FIG. 4(a) vertically reversed, with coordinate axes and a visual recognition direction depicted.

FIG. 6(a) depicts an enlarged view of main parts in an A-A section in FIG. 4(a), and FIG. 6(b) depicts an enlarged sectional descriptive diagram in which main parts in a B-B section in FIG. 4(a) are vertically reversed and are provided with coordinate axes.

FIG. 7(a) depicts a perspective descriptive diagram in which a C-C section in FIG. 4(a) is provided with coordinate axes, and FIG. 7(b) depicts an enlarged sectional descriptive diagram in which an XZ plane in FIG. 7(a) viewed from a Y-axis direction is provided with coordinate axes.

FIG. 8 depicts a shape of a cross ridgeline part of a hemispherical-surface workpiece, in which FIG. 8(a) depicts a shape of the cross ridgeline part without deburring viewed from a visual point α, FIG. 8(b) depicts a shape obtained by deburring the cross ridgeline part viewed from the visual point α by a tool with a known spherically-shaped tip part, and FIG. 8(c) depicts a shape obtained by deburring the cross ridgeline part viewed from the visual point α by the cross hole deburring tool according to the present invention. Also, FIG. 8(d) depicts a shape of the cross ridgeline part depicted in FIG. 8(a) viewed from a visual point β, FIG. 8(e) depicts the shape depicted in FIG. 8(b) viewed from the visual point β, and FIG. 8(f) depicts the shape depicted in FIG. 8(c) viewed from the visual point β.

FIG. 9(a) depicts an enlarged view of main parts on the XZ plane of FIG. 7(b), and FIG. 9(b) depicts an enlarged detailed view of an (i) part depicted in FIG. 9(a).

FIG. 10(a) depicts a sectional view in which the tip part of the cross hole deburring tool according to the present invention is arranged inside a body of a rotary valve, and FIG. 10(b) depicts a D-D sectional view of FIG. 10(a) after deburring machining by the cross hole deburring tool of the present invention.

FIG. 11(a) depicts a sectional view in which a tip part of a deburring tool with the known spherically-shaped tip part is arranged inside the body of the solid of revolution, and FIG. 11(b) depicts a E-E sectional view of FIG. 11(a) after deburring machining by the known spherically-shaped tip part.

FIG. 12 depicts a longitudinal sectional view of the rotary valve.

FIG. 13 depicts a perspective view of the outer appearance of the rotary valve.

FIG. 14 depicts respective examples of a workpiece, in which FIG. 14(a) depicts a sectional perspective view in which a cylindrical-surface workpiece having a cylindrical hollow part is subjected to deburring machining by the deburring tool with the known spherically-shaped tip part, FIG. 14(b) depicts a sectional perspective view in which the cylindrical-surface workpiece having the cylindrical hollow part is subjected to deburring machining by the cross hole deburring tool according to the present invention, and FIG. 14(c) depicts a half-transverse sectional view of a spool valve.

FIG. 15 depicts still another example, depicting a sectional perspective view in which the cylindrical-surface workpiece having the cylindrically-shaped hollow part is subjected to deburring machining by the cross hole deburring tool according to the present invention.

### DESCRIPTION OF EMBODIMENTS

In the following, preferred embodiments of the cross hole deburring tool, cross hole deburring method, and rotary valve machined by using the same of the present invention are described in detail based on the drawings.

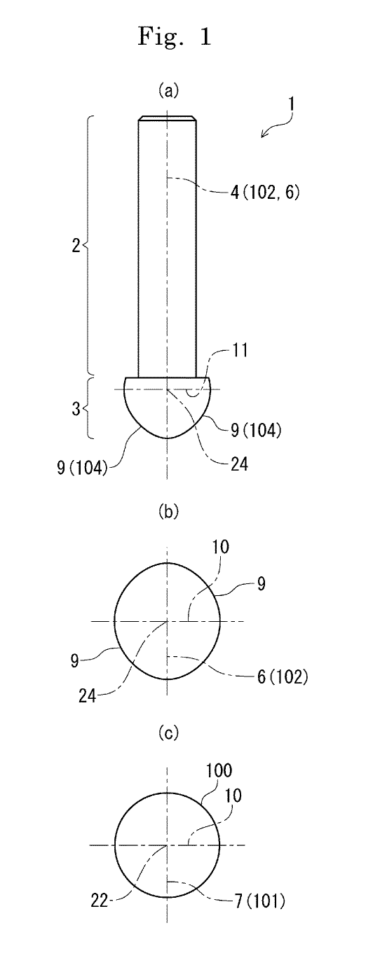

In FIG. 1, (a) is a side surface outer shape view of a tool main body 1, which is an example of the cross hole deburring tool according to the present invention, (b) is a side surface outer shape view of a bow-shaped solid of revolution depicting the shape of a tip part, and (c) is a side surface outer shape view of a sphere, that is, a perfect circle.

In FIG. 1(a), the tool main body 1 includes a shank 2 on a cylindrical base end side in an axial direction and a tip part 3 on a tip side in the axial direction for performing rotary cutting. In the drawing, with an upper side as a base end side, the tool is rotatably held to a main shaft of a machine tool or the like by taking a rotation axis 4 as a shaft center, and performs deburring by subjecting a workpiece to rotary cutting by a plurality of cutting edges provided to the tip part 3. The shape of the tip part 3 is a shape of a rotation trajectory plane formed by the cutting edges when the tip part 3 is rotated by taking the rotation axis 4 as a shaft center, and that shape can be formed by an outer surface shape of a bow-shaped solid of revolution, which will be described below.

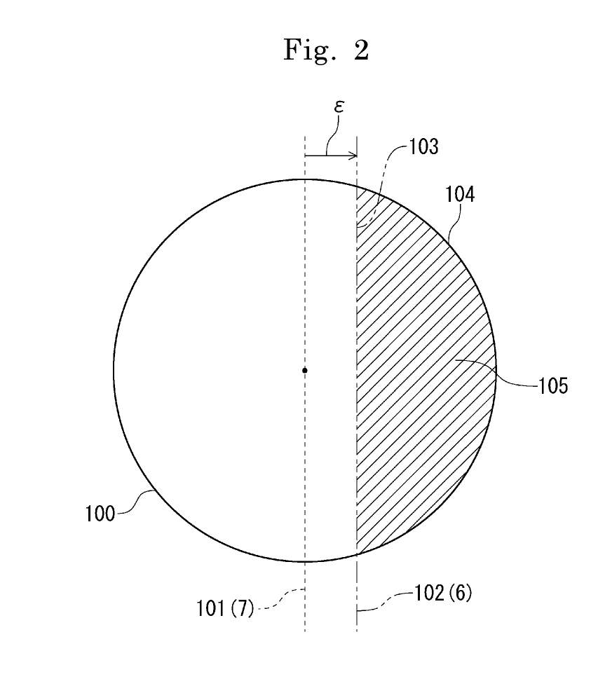

In FIG. 2, a circle 100 is set. One diameter axis 101 forming a diameter of that circle 100 is taken. On the same plane as the circle 100, an eccentric axis 102 is taken, which is away from the diameter axis 101 by a predetermined eccentric distance ε parallel to the diameter axis 101 and smaller than the radius of the circle 100. A line segment 103 obtained by cutting the eccentric axis 102 by the circle 100 is set as a chord. A minor arc 104 on the circle 100 obtained by being cut by that chord 103 is set. A bow shape 105 is set in a closed region surrounded by the chord 103 and the minor arc 104. A solid of revolution formed by rotating this bow shape 105 about the eccentric axis 102 (chord 103) by 360° is a bow-shaped solid of revolution.

Graphic elements depicted in FIG. 2 correspond to those in FIG. 1. The rotation axis 4 of FIG. 1(a) and an auxiliary line 6 of FIG. 1(b) correspond to the eccentric axis 102 in FIG. 2, and an auxiliary line 7 of FIG. 1(c) corresponds to the diameter axis 101 in FIG. 2. That is, the shape of a minor arc 9 in FIG. 1 corresponds to the minor arc 104 in FIG. 2, and the shape of the tip part 3 in FIG. 1 corresponds to the bow-shaped solid of revolution formed by rotating the bow shape 105 in FIG. 2 about the eccentric axis 102 (arc 103) by 360°.

An auxiliary line 10 in FIG. 1(b) vertically divides the arc-shaped solid of revolution equally into two, and matches an auxiliary line 11 of FIG. 1(a). That is, the tip part 3 in FIG. 1(a) is set so as to transverse and divide the bow-shaped solid of revolution of FIG. 1(b) into two on a slightly upper side of an auxiliary 10 and matches the outer surface shape of a lower-side divisional body. Thus, the shape of the tip part 3 depicted in FIG. 1(a) is part of the outer surface shape of the bow-shaped solid of revolution depicted in FIG. 1(b). Also, since the outer diameter of the tip part 3 is larger than a columnar diameter of the shank 2, the tool main body 1 has a horsetail-type shape, with the tip part 3 as a head part.

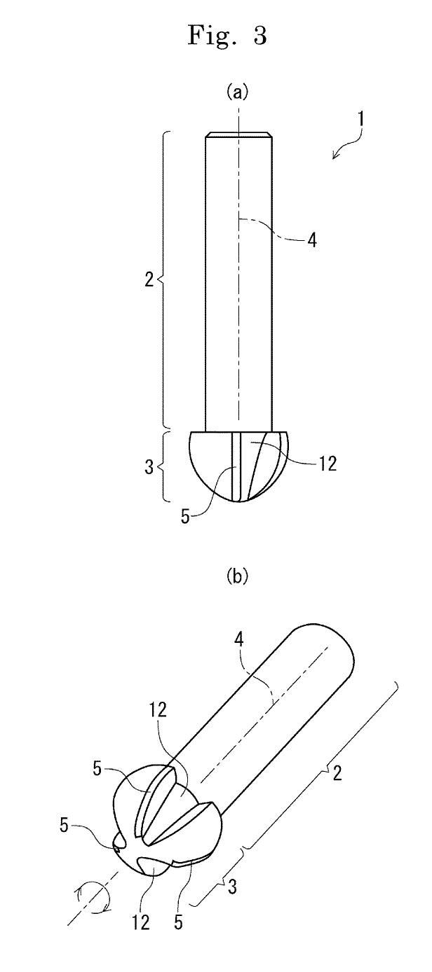

In FIG. 3, in the tip part 3, a triple-edged blade is formed, having three groove parts 12 equidistantly provided to the tool main body 1 in a rotation radius vector direction and cutting edges 5 formed along these groove parts 12. As for the number of cutting edges 5, a double-edged blade or a quadruple-edged blade may be used. Any shape, number, and so forth of the cutting edges 5 and the groove parts 12 can be selected in accordance with the material of the workpiece, the machining method, and so forth unless they have an influence on the shape of the tip part 3. Chips produced by rotary cutting are removed so as to be scooped into these groove parts 12.

In the present example, as depicted in FIG. 3(a), the shape of the groove part 12 is formed so that the shape of the cutting edge 5 is parallel to the direction of the rotation axis 4 of the tool main body 1 in a side view. However, this shape of the groove part 12 may be formed so as to be in a curved line shape in which the cutting edge 5 is tilted with respect to the direction of the rotation axis 4 or the cutting edge 5 is twisted. Furthermore, depending on the groove shape, the cutting edge 5 may be formed to have a shape of high strength having a material thickness.

Next, setting of the above-described eccentric distance ε is described.

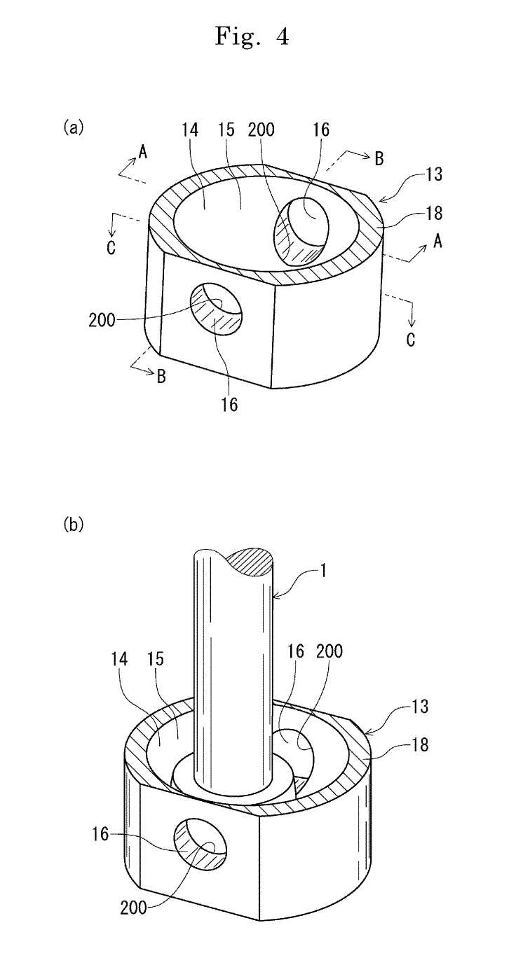

In FIG. 4(a), a hemispherical-surface workpiece 13 has a spherically-shaped hollow part 14 inside, and the inner circumferential surface of this spherically-shaped hollow part 14 is a spherical surface part 15 formed in a recessed-shaped spherical surface shape. With respect to this spherical surface part 15, a through path 16 in a cylindrical shape having a center axis penetrates to a position opposing the spherical surface part 15, and two cross ridgeline parts 200 are formed on the spherical surface part 15. The center axis of the through path 16 does not pass through the spherical center of the spherical surface part 15, and is included in a plane perpendicular to a plane formed by an end face 18 passing through the spherical center of the spherical surface part 15 and passing through the spherical center of the spherical surface part 15 and is also parallel to the plane formed by the end face 18. This through path 16 is drilled from outside the hemispherical-surface workpiece 13, and cross hole burrs warping toward the spherical center of the spherically-shaped hollow part 14 occur over the entire periphery of the cross ridgeline parts 200.

In FIG. 4(a), an A-A section depicts a section perpendicular to the center axis of the through path 16 and passing through a spherical center point 19 of the spherical surface part 15, a B-B section depicts a section including the center axis of the through path 16 and perpendicular to the plane formed by the end face 18, and a C-C section depicts a section including the center axis of the through path 16 and parallel to the plane formed by the end face 18. Therefore, the A-A section, the B-B section, and the C-C section are perpendicular to one another.

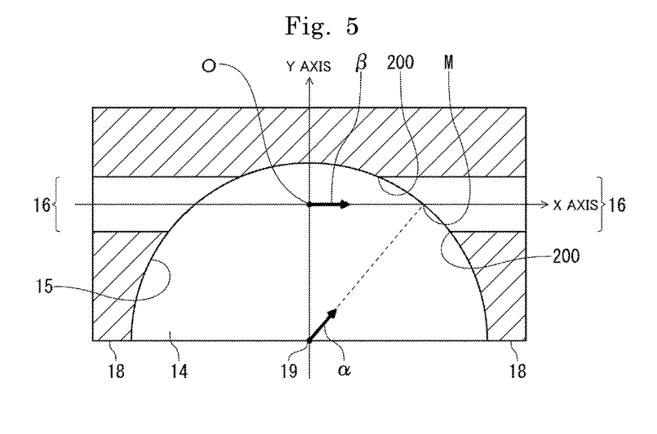

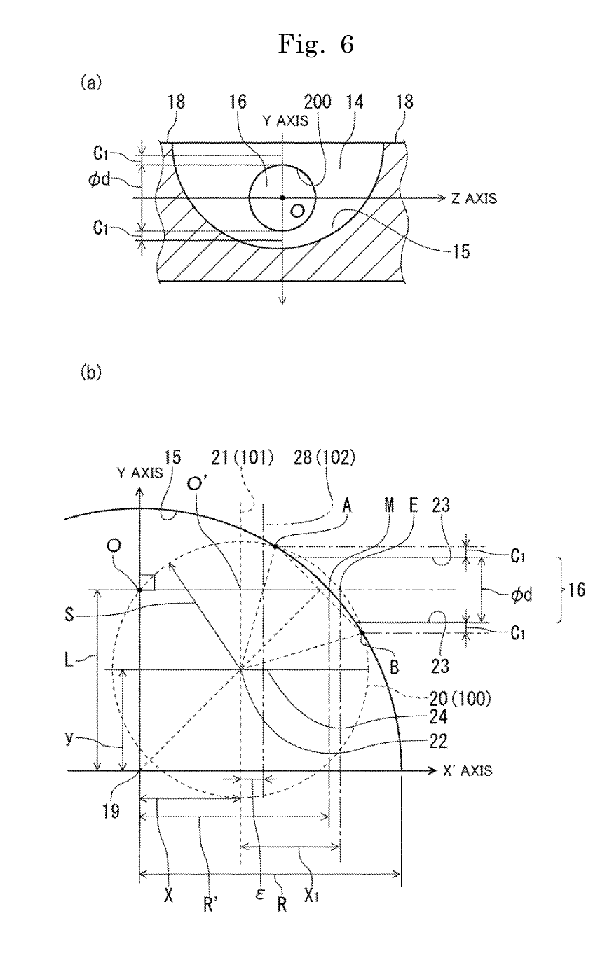

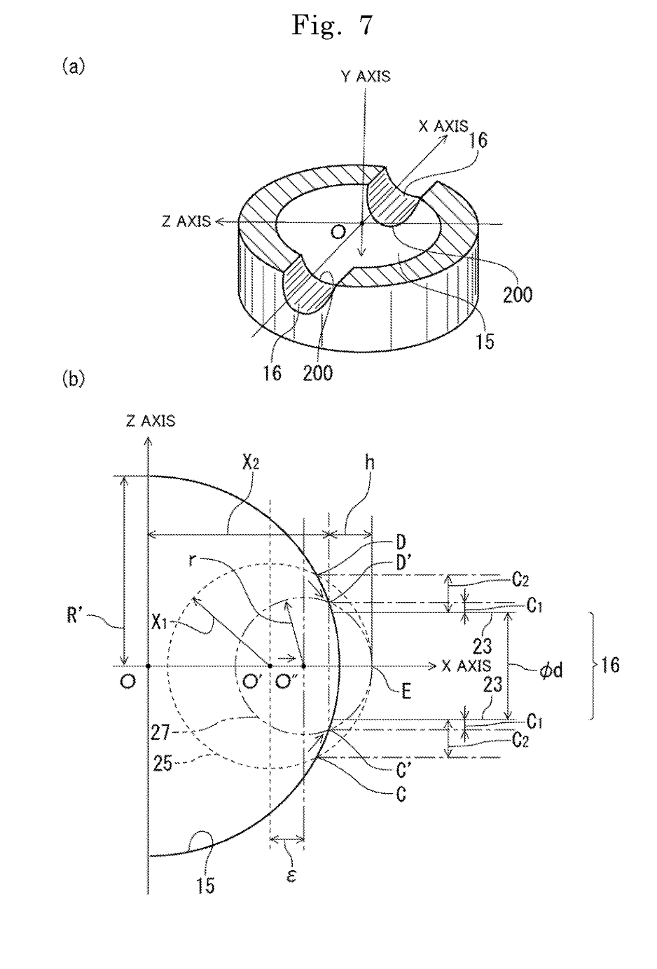

FIG. 5 is a sectional view of the B-B section in FIG. 4(a) vertically reversed. The X axis corresponds to the X axis depicted in FIG. 7, and the Y axis corresponds to the Y axis depicted in FIG. 6 and FIG. 7(a). Also, a visual point α indicates a visual recognition direction from a spherical center point 19 of the spherical surface part 15 to a point M on the center axis of the through path 16, and a visual point β indicates a visual recognition direction from a point O on the center axis of the through path to the cross ridgeline part 200 along the center axis of the through path 16.

FIG. 6(a) is an enlarged view of the through path 16 in the A-A sectional view of FIG. 4(a), depicting the cross ridgeline part 200 of the through path 16 from the visual point β in FIG. 5. The Y axis in FIG. 6(a) is an axis perpendicular to the plane formed by the end face 18 in FIG. 4(a) and passing through the spherical center point 19 of the spherical surface part 15. The Z axis is an axis parallel to the plane formed by the end face 18 in FIG. 4(a) and perpendicular to the center axis of the through path 16.

In FIG. 6(a), a deburring width having a length C₁ is set to each portion of the through path 16 with a diameter of φd in a vertical direction on the Y axis. The deburring width C₁ can be set as appropriate in accordance with a deburring target value.

FIG. 6(b) is an enlarged view of the B-B sectional view of FIG. 4(a) vertically reversed. The X′ axis in FIG. 6(b) is an axis parallel to the center axis of the through path 16 and included in the plane formed by the end face 18. The Y axis is an axis perpendicular to the X′ axis, passing through the spherical center point 19 of the spherical surface part 15, and taking a direction of the spherical surface part 15 as a positive direction (corresponding to the Y axis in FIG. 6(a)).

In FIG. 6(b), a circle 20 is a side view of the spherically-shaped tip part with the shape of the tip part being formed in a single spherical-surface shape. A line 21, which is a diameter axis of the circle 20, corresponds to the auxiliary line 7 of FIG. 1(c), and a center point 22 corresponds to a center point 22 in FIG. 1(c). A radius S of the spherically-shaped tip part is larger than the sum of the diameter φd of the through path 16 and the cross hole deburring widths C₁ thereabove and therebelow.

A point A is a point of intersection of a straight line parallel to the center axis of the through path 16 by a distance of C₁ in a positive direction on the Y axis from an inner surface 23 of the through path 16, and the spherical surface part 15. A point B is a point of intersection of a straight line parallel to the center axis of the through path 16 by the distance of C₁ in a negative direction on the Y axis from the inner surface 23 of the through path 16, and the spherical surface part 15. The circle 20 depicted is in a state of being arranged so as to pass through the point A and the point B. A point E is a point of intersection of the circle 20 and the center axis of the through path 16. A point M is a point of intersection of an arc AB and the center axis of the through path 16, the arc being in a circular arc shape drawn by the spherical surface part 15 in an X′Z plane and formed by the points A and B. The position of the center point 22 of the circle 20 is uniquely defined by the positions of the two points A and B and the radius S of the spherically-shaped tip part (the radius of the circle 20).

Here, a distance x and a distance y represent a distance in an X′-axis direction between the spherical center point 19 and the center point 22 and a distance in a Y-axis direction therebetween, respectively; L represents a distance in the Y-axis direction between the spherical center point 19 and the center axis of the through path 16; R represents the radius of the spherical surface part 15; R′ represents a distance in the X′-axis direction between the spherical center point 19 and the point M; and X₁ represents a distance in the X′-axis direction between the point E and the line 21. A point O is a point of intersection where the center axis of the through path 16 and the Y axis go straight, and

a point O′ is a point of intersection of the center axis of the through path 16 and the line 21.

Here, the following relational expressions hold.

R′=\sqrt{R²−L²} [Equation 1]

x₁=\sqrt{S²−(L−y)²} [Equation 2]

FIG. 7(a) depicts a C-C section of the hemispherical-surface workpiece 13 of FIG. 4(a), and the through path 16 is equally divided into two in the C-C section passing through its center axis. The X axis is provided so as to match the center axis of the through path 16. With respect to the X axis, the Y axis and the Z axis are depicted so as to match those in the above-described drawing.

FIG. 7(b) is an XZ plane view of FIG. 7(a). A circle 25 depicts an outer diameter when the spherically-shaped tip part formed by rotation of the circle 20 by taking the line 21 as a rotation axis in FIG. 6(b) is cut along the XZ plane. Two points C and D each indicate a point of intersection of the circle 25 and the spherical surface part 15 in the XZ plane. Since a point O′ of the circle 25 is on the X axis, the two points C and D are at axially symmetrical positions with respect to the center axis of the through path 16 (X axis). A point E is a point of intersection of the center axis of the through path 16 and the circle 20, and matches the point E in FIG. 6(b).

As described above, the circle 25 depicts the spherically-shaped tip part. When a distance in the Z-axis direction between the point of intersection C (or the point of intersection D) of the spherical surface part 15 and the spherically-shaped tip part and the inner surface 23 of the through path 16 is taken as C₂, C₂ is larger than the deburring width C₁ in the Y-axis direction.

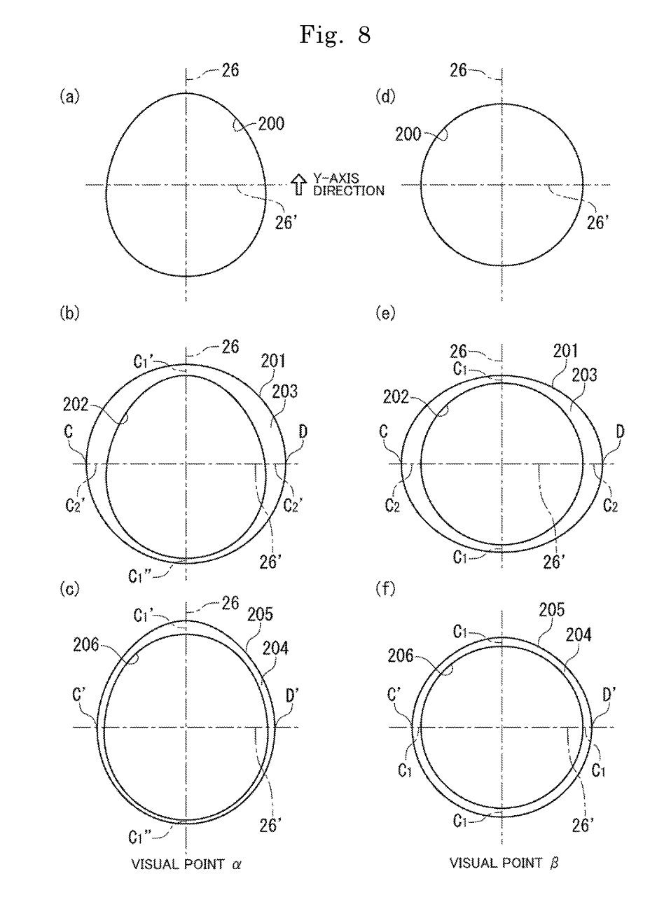

FIG. 8(a) depicts the shape of the cross ridgeline part 200 when the through path 16 of the hemispherical-surface workpiece 13 is viewed from the visual point a depicted in FIG. 5. Since the cross ridgeline part 200 is a crossline of the cylindrically-shaped through path 16 and the spherical surface part 15, from the visual point a, the cross ridgeline part 200 has a distorted oval shape which is symmetrical with respect to an auxiliary line 26 included in an X′Y plane but is asymmetrical with respect to an auxiliary line 26′ included in the XZ plane. On the other hand, from the visual point depicted in FIG. 5, as depicted in FIG. 6(a) (or FIG. 8(d)), the cross ridgeline part 200 of the through path 16 has a perfect circle shape.

In FIG. 8(b), a ridgeline 201 is a crossline when the spherical surface part 15 is cut by the spherically-shaped tip part, and has an approximately perfect circle shape from the visual point α and an oval shape with respect to the auxiliary line 26 included in the X′Y plane as depicted in FIG. 8(e) from the visual point β. Also, a crossline with the inner surface 23 of the through path 16 when cutting is made by the spherically-shaped tip part is a ridgeline 202, and a curved surface formed between this ridgeline 202 and the ridgeline 201 is a machined surface 203 by the spherically-shaped tip part.

Also, since a width C₁′ and a width C₁″ depicted in FIG. 8(b) and FIG. 8(e) are those when the deburring width C₁ in the Y-axis direction in FIG. 6(b) is viewed from the visual points α and β, the deburring width and the width C₁″ are slightly different from each other when viewed from the visual point a, but are the same when viewed from the visual point β. A width C₂′ in FIG. 8(b) is a deburring width when the deburring width C₂ in the Z-axis direction in FIG. 7(b) is viewed from the visual point a, and the width C₂′ is larger than or C₁″. In this manner, when cross hole deburring is performed by the spherically-shaped tip part, the surface width of the machined surface 203 is nonuniform.

Thus, in the present invention, while the radius S of the circle 20 in FIG. 6(b) is maintained, the rotation axis 21 is decentered (moved) to form a bow-shaped solid of revolution and, by reducing the rotation radius on the XZ plane, the deburring width in the Y-axis direction and the deburring width in the XZ plane direction are adjusted to be the same.

In FIG. 7(b), points of intersections of a straight line parallel to the center axis of the through path 16 at a distance of C₁ in the Z-axis direction from the inner surface 23 of the through path 16 and the spherical surface part 15 are taken as C′ and D′. A circle passing through these two points of intersections C′ and D′ and the point of intersection E is taken as an eccentric circle 27. A point O″ is the center point of this eccentric circle 27.

Here, X₂ represents a distance in the X-axis direction between the point O and the point C′ (or the point D′), h represents a distance in the X-axis direction between the point C′ (or the point D′) and the point E, φd represents the diameter of the through path 16, r represents a radius of the eccentric circle 27 described above, and an eccentric distance ε represents a distance in the X-axis direction between the center point O′ of the circle 25 and the center point O″ of the eccentric circle 27.

From the above, the following relational expressions hold.

$$\begin{matrix}{x}_{2} = \sqrt{{R}^{′2} - {( \frac{Φ d + 2 {c}_{1}}{2} )}^{2}} & [ Equation 3 ] \\ h = x + {x}_{1} - {x}_{2} & [ Equation 4 ] \\ r = \frac{{( Φ d + 2 {c}_{1} )}^{2} + 4 {h}^{2}}{8 h} & [ Equation 5 ] \\ ɛ = {x}_{1} - r = {x}_{1} - \frac{{( Φ d + 2 {c}_{1} )}^{2} + 4 {h}^{2}}{8 h} & [ Equation 6 ]\end{matrix}$$

The shape of the tip part 3 according to the present invention depicted in FIG. 1(a) is a shape obtained by graphic operation depicted in FIG. 2 with ε derived from the above-described Equation 6 taken as an eccentric distance, that is, an outer surface shape of the bow-shaped solid of revolution formed by the eccentric axis 102.

Also, the eccentric circle 27 depicted in FIG. 7(b) depicts a state in which the tip part 3 of the cross hole deburring tool of the present invention in section on the XZ plane performs rotary cutting of the spherical surface part 15. Therefore, the point O′ corresponds to the diameter axis 101 of FIG. 2, and the point O″ corresponds to the eccentric axis 102 in FIG. 2 and the rotation axis 4 in FIG. 1(a).

In FIG. 8(c), a ridgeline 205 is a crossline when the spherical surface part 15 is subjected to rotary cutting by the tip part 3 of the cross hole deburring tool of the present invention, and a ridgeline 206 is a crossline when the inner surface 23 of the through path 16 is subjected to rotary cutting by the tip part 3 of the cross hole deburring tool of the present invention. A curved surface formed between these ridgeline 205 and ridgeline 206 forms a machined surface 204 obtained by deburring. When viewed from the visual point a, the widths C₁′ and C₁″ are slightly different from each other. As depicted in FIG. 8(f), however, when viewed from the visual point β, a substantially uniform deburring width over the entire periphery is formed.

By providing an eccentric axis (a line 28 in FIG. 6(b)) at a position the eccentric distance ε away from the center point O′ (the line 21 in FIG. 6(b)) of the circle 25 in FIG. 7(b), as with the conceptual diagram of FIG. 2, a bow-shaped solid of revolution can be formed in a closed region surrounded by the line 28 and the circle 25. While the radius S of the spherically-shaped tip part in an X′Y planar view in FIG. 6(b) is maintained, the rotation radius of the spherically-shaped tip part in the XZ plane in FIG. 7(b) can be reduced from the radius X₁ to the radius r. Thus, as depicted in FIG. 8(f) (or FIG. 8(c)), the surface width of the machined surface 204 can be finished so as to have a substantially uniform width over the entire periphery.

In this manner, with the tool main body 1 according to the present invention, the shape of the tip part 3 can be adjusted to a shape adapted to a width across corners (minor axis and major axis) of the cross ridgeline part where a burr occurs. The present invention is effective when the surface width of the machined surface of the cross ridgeline part becomes nonuniform by rotation cutting with a blade having a tip part in a spherical surface shape and, in particular, is effective in most cases if the shape of the cross ridgeline part is a convex closed-curve shape with plane symmetry. For example, the present invention is also effective even when the center axis of the through path 16 and the Y axis cross as being slightly tilted in FIG. 6(b) and, furthermore, is effective even when the workpiece is a cylindrical inner circumferential surface, which will be described further below.

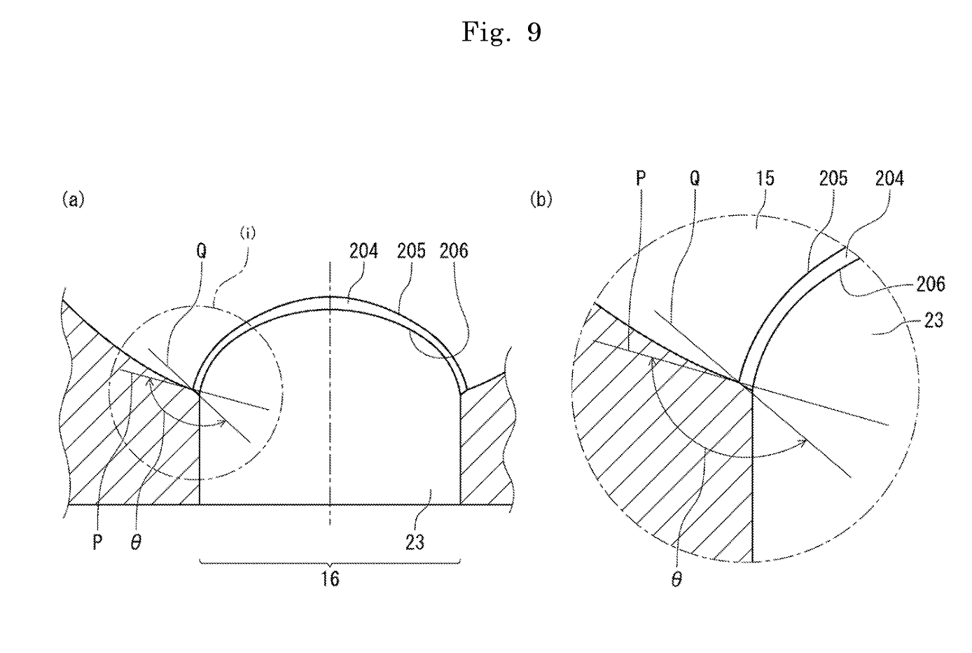

FIG. 9(a) depicts an enlarged detailed view of a cross part between the through path 16 and the spherical surface part 15 in FIG. 6(b). At the point of intersection C′ of the ridgeline 205 and the XZ plane (matching the point C′ in FIG. 7(b)), a tangent P represents a tangent of the spherical surface part 15 in an XZ section, a tangent Q represents a tangent of the machined surface 204 in the XZ section, and an angle θ represents a tangent angle formed by the two tangents P and Q. FIG. 9(b) is an enlarged detailed view of an (i) part depicted in FIG. 9(a), in which the machined surface 204 and the spherical surface part 15 cross along the ridgeline 205 at an obtuse angle.

Here, in general, when a workpiece is cut by a blade, the workpiece is divided into a region in which a cutting edge enters the workpiece and a region in which the cutting edge goes away from the workpiece. In the region in which the cutting edge goes away from the workpiece, the workpiece is scooped up by the cutting edge.

For example, in FIG. 7(b), the eccentric circle 27 schematically represents the tip part 3 according to the present invention at the time of cutting. When its rotating direction is counterclockwise in the drawing, the hemispherical-surface workpiece is scooped up along a region on a point D′ side, that is, the ridgeline 205 on a right side of the center line 26 in FIG. 8(c) and FIG. 8(f). In this manner, in the region where the workpiece is scooped up by the cutting edge, a secondary burr by cutting tends to occur.

On the other hand, regarding a relation between a crossing angle formed by a scooping-up surface of the cutting edge and the surface of the workpiece and burrs occurring on a ridgeline part of the machined surface, the following facts have been generally known.

When a blade for cutting a portion near a surface layer of a workpiece goes away from the workpiece at a predetermined crossing angle with the surface of the workpiece, if the crossing angle between the cutting-edge scooping-up surface and the workpiece is on the order of 90°, chips are left near the machined-surface ridgeline part as being scooped up together with a surface portion of a non-cut workpiece, and tend to become burrs. However, if the crossing angle is large such as on the order of 135° or larger, when the cutting edge goes away from the surface of the workpiece, scooping-up of a non-cut and excessive surface portion of the workpiece is suppressed, and burrs hardly occur.

When rotary cutting is performed by the tool according to the present invention, the tangent angle θ formed by tangent P and the tangent Q depicted in FIG. 9 depends on the deburring width C₁ and the eccentric distance ε, which can be set at any value. Therefore, if the deburring width C₁ and the eccentric distance ε are adjusted so that this tangent angle θ is an angle larger than that on the order of 135° depending on the shape of the hemispherical-surface workpiece 13 as a machining target, it is possible to suppress an occurrence of a second burr in the region where the workpiece is scooped up, and therefore this is more suitable.

Next, the operation of the present embodiment is described. As depicted in FIG. 4(b), when deburring machining of the cross ridgeline part 200 of the hemispherical-surface workpiece 13 is performed by the tool main body 1 according to the present invention, the tip part 3 is caused to enter the inside of the workpiece from an opening side of the spherical surface part 15, and the tool main body 1 is rotated to be pressed onto the cross ridgeline part 200, thereby performing chamfering process. The machined surface by this chamfering process is the machined surface 204 depicted in FIG. 8(c) and FIG. 8(f).

First, the shank 2 is rotatably mounted on a main shaft of a machine tool, and the tip part 3 of the tool main body 1 is caused to approach a cross ridgeline part, which is a cutting target, in the hemispherical-surface workpiece 13. In this approaching operation, causing the blade edge 3 to enter the inside of the spherical surface part 15 while the plane formed by the rotation axis 4 of the tool main body 1 and the end face 18 of the hemispherical-surface workpiece 13 is held so as to be substantially perpendicular is enough, and complex operation is not required, such as changing the orientation of the tool main body 1 in accordance with the cutting location.

Next, while the tool main body 1 is rotated at an appropriate number of revolutions, the rotation axis 4 is moved to a predetermined position with respect to the hemispherical-surface workpiece 13, thereby pressing the rotating tip part 3 (cutting edge 5) to the cross ridgeline part 200 for rotary cutting. Thus, in the cross deburring method according to the present invention, with only operation of combining relative movements of the tool main body 1 and the workpiece in a three-dimensional manner, deburring machining of the cross ridgeline part 200 of the hemispherical-surface workpiece 13 can be achieved.

In the present example, regarding the position of the tip part 3 at the time of cutting, the center point of the bow-shaped solid of revolution can be positioned at a point 24 in FIG. 6(b) and the rotation axis can be positioned at the eccentric axis 28 in FIG. 6(b) and the point O″ in FIG. 7(b). That is, only by rotary cutting by moving X′Y Z coordinates of the center point 24 of the bow-shaped solid of revolution to a position of (X′, Y, Z)=(x+ε, y, 0), finishing can be made to obtain the machined surface 204 with a substantially uniform deburring width over the entire periphery as depicted in FIG. 8(c) and FIG. 8(f).

Since this machined surface 204 is obtained with rotary cutting by pressing the tip part 3 of the tool main body 1 to the cross ridgeline part 200, the machined surface 204 has a substantially uniform surface width over its entire periphery, and manufacturing cost of a machined product (such as a rotary valve) by simplifying the rotary cutting process can also be reduced. Although this machined surface 204 has a linear cutting mark slightly left by rotary cutting in the direction of the XZ plane, its surface roughness is homogeneous, and a surface with asperities is not formed.

Also, since the tool main body 1 according to the present invention has a simple structure formed of the shank 2 and the tip part 3 formed of a bow-shaped solid of revolution, compared with a blade with a complex shape, it is possible to reduce tool manufacturing cost and also contribute to a reduction in administrative and maintenance cost.

Also, since the operation of the tool main body 1 is a simple operation by parallel movement of the tool, the tool can be used in a normal turning machine and, unlike an NC machine tool, generation of a numerical value program with three-dimensional coordinates, complex operation means, and so forth are not required. Furthermore, depending on the shaped to be machined, machining from material machining (such as cutting, boring, and drilling) to deburring can be completed by one process machine. Thus, the machining process can be simplified to reduce manufacturing cost and, furthermore, the reduction in process division allows finishing into high-quality products in a short period of time.

Next, an example of use is described in which the tool main body 1 according to the present invention is used for a body 30 of a rotary valve. Inside the body 30 in this example, as will be described in the following, as with the hemispherical-surface workpiece 13, a spherical surface part 34 with an inner circumferential surface formed in a recessed spherical shape is provided.

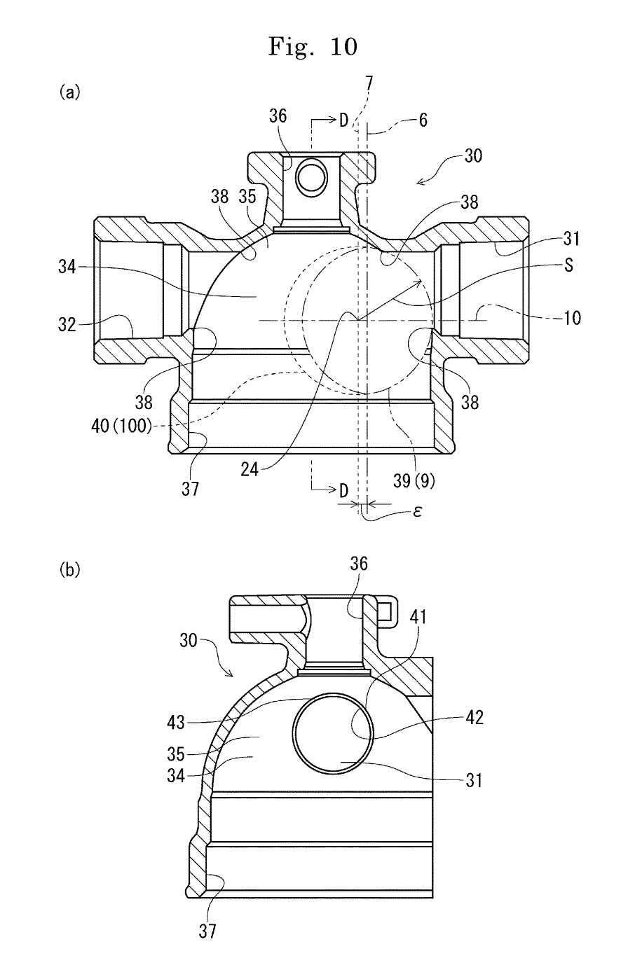

FIG. 10(a) depicts a longitudinal sectional view of the body 30 before deburring machining. The body 30 is formed of a material such as, for example, bronze, brass, or stainless steel, into a one-piece structure, and has outflow/inflow ports 31 and 32 (corresponding to the through path 16) corresponding to the through path 16 and an exhaust port 33 crossing these outflow/inflow ports 31 and 32. On part of the inner circumference of the body 30, a valve body accommodating part 35 (corresponding to the spherically-shaped hollow part 14) having a spherical surface part 34 (corresponding to the spherical surface part 15) is formed. On an upper part side of this valve body accommodating part 35, a shaft inserting part 36 is provided. On a lower part side, an opening 37 is formed so as to be open. These outflow/inflow ports 31 and 32 are subjected to drilling from the outside to the inside, and a cross ridgeline part 38 has a burr warping to the inside occurring over the entire periphery. Also, an outer shape 39 of a bow-shaped solid of revolution schematically depicts a state in which the tip part 3 in a bow-shaped solid of revolution shape of the tool main body 1 according to the present invention is pressed to the cross ridgeline part 38. A circle 40 schematically depicts an outer shape of a sphere (spherically-shaped tip part) serving as a reference of the outer diameter 39. The auxiliary line 7 depicts a diameter axis of the circle 40, and the auxiliary line 6 corresponds to the rotation axis of the bow-shaped solid of revolution, that is, the rotation axis 4 in FIG. 1(a). The eccentric distance ε forming the bow-shaped solid of revolution of the tip part 3 can be derived from various numerical values of the body 30 as described above.

FIG. 10(b) depicts a D-D section of FIG. 10(a) after the cross ridgeline part 38 is subjected to deburring machining by the tip part 3 of the tool main body 1 of the present invention. A ridgeline 41 is a crossline of the spherical surface part 34 to be cut by the tip part 3. In a sectional view perpendicular to the center axis of the outflow/inflow port 31 (corresponding to the visual point β in FIG. 5), the outflow/inflow port 31 and the ridgeline 41 are each formed in a perfect circle shape. A surface formed between the ridgelines 41 and 42 is a machined surface 43 by deburring machining, and these correspond to ridgelines 205 and 206 and the machined surface 204 in FIG. 8(c). As depicted, the surface width of the machined surface 43 is a substantially uniform deburred width over the entire periphery.

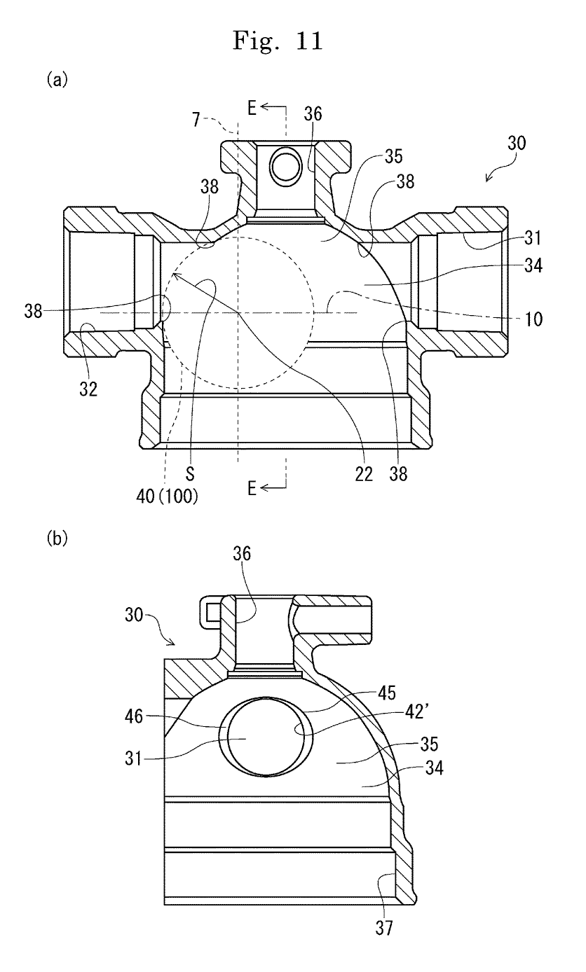

On the other hand, FIG. 11(a) schematically depicts a state in which the spherically-shaped tip part formed in a single spherical surface shape is pressed to the cross ridgeline part 38. The auxiliary line 7 corresponds to the above-described diameter axis 21. FIG. 11(b) depicts an E-E section of FIG. 11(a) after the cross ridgeline part 38 is subjected to deburring machining by the spherically-shaped tip part. A ridgeline 45 is a crossline of the spherical surface part 34 to be cut by the tip part 3. In a sectional view perpendicular to the center axis of the outflow/inflow port 31 (corresponding to the visual point β in FIG. 5), the outflow/inflow port 31 is depicted in a perfect circle shape. A surface formed between ridgelines 42′ and 45 is a machined surface 46 by deburring machining, and these correspond to the ridgelines 202 and 201 and the machined surface 203 in FIG. 8(b). As depicted, the surface width of the machined surface 46 is a nonuniform width with a wide lateral width and a narrow longitudinal width.

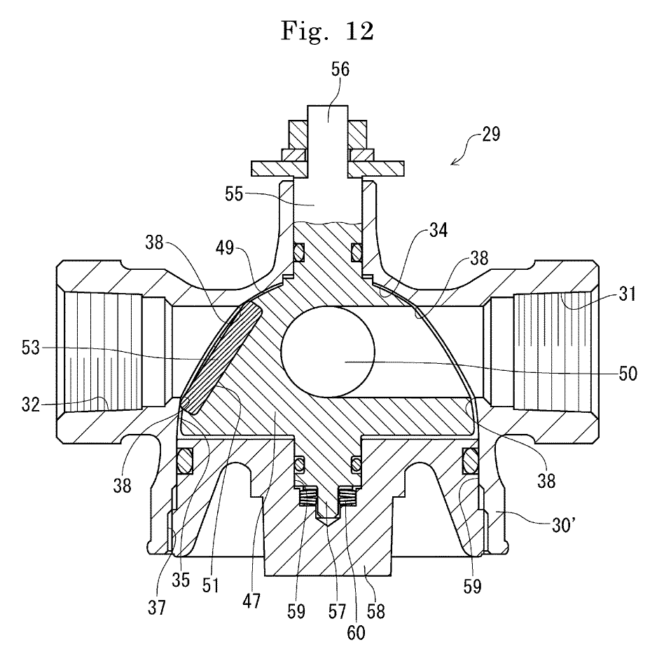

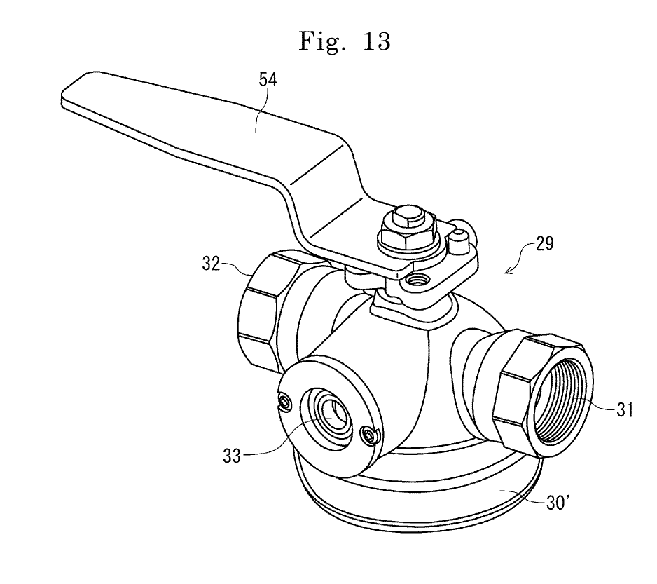

FIG. 12 is a longitudinal sectional view in which a valve body 47 is mounted on a body 30′ of a rotary valve 29 of another example, and FIG. 13 is a perspective view of the outer appearance of this rotary valve 29. This rotary valve 29 is a valve suitable as, for example, a quick exhaust valve for railway vehicles or the like. Note that regarding the body 30′ of this rotary valve 29, a portion identical to that of the body 30 is provided with the same reference numeral and description thereof is omitted.

The valve body 47 is inserted in the valve body accommodating part 35 from the opening 37 of the body 30′, and is rotatably mounted in a state of being positioned in a vertical direction. A spherically-shaped surface part 49 is provided to part of the valve body 47. In the present example, the outer circumferential surface of this valve body 47 is formed of the spherically-shaped surface part 49 in a hemispherical shape.

On the outer circumferential surface of the spherically-shaped surface part 49, a plurality of through ports 50 communicable with the outflow/inflow ports 31 and 32 or the exhaust port 33 are formed in three ways. In a lateral direction crossing these through ports 50, an attachment groove 51 which can oppose the outflow/inflow ports 31 and 32 or the exhaust port 33 is formed. To the attachment groove 51, a seal member 53 with elasticity capable of sealing the outflow/inflow ports 31 and 32 or the exhaust port 33 is attachably and detachably attached. In this example, the attachment groove 51 is a circular recessed groove, and the seal member 53 is formed in a disc shape which can fit in this circular recessed groove 51. The through ports 50 are each formed in a full bore shape having a diameter substantially equal to that of the outflow/inflow ports 31 and 32 or the exhaust port 33 to suppress a pressure loss at the time of communication to these outflow/inflow ports 31 and 32 or the exhaust port 33.

On an upper part of the valve body 47, an upper stem 55 where a handle 54 can be mounted is integrally or separately provided. At a handle attachment position of this upper stem 55, a fit-in protruding part 56 is formed. On an opposite side of the upper stem 55, a lower stem 57 is integrally provided. The valve body 47 has a shape insertable in the spherical surface part 34. In this case, the through ports 50 and the seal member 53 rotate so as to face the outflow/inflow ports 31 and 32 or the exhaust port 33 to switch a flow path.

The seal member 53 attached to the valve body 47 is formed of a high polymer material, for example, PTFE (polytetrafluoroethylene) or PTFE containing carbon fiber. When the valve body 47 rotates, the seal member 53 rotates integrally with this valve body 47 to be able to seal each of the outflow/inflow ports 31 and 32 or the exhaust port 33 and, on the other hand, allows a fluid to flow when shifted from the outflow/inflow ports 31 and 32 or the exhaust port 33.

A lid member 58 is provided in a shape capable of covering the opening 37 via a thrust washer or the like. On its upper outer circumference, a columnar part 59 is formed. Between the lower stem 57 of the valve body 47 and an insertion hole part 59 of the lid member 58, a spring member 60 formed of disc springs on upper and lower surfaces is attached. An elastic force of this spring member 60 presses the seal member 53 to hermetically seal any one of the outflow/inflow ports 31 and 32 or the exhaust port 33, and the outflow/inflow ports 31 and 32 and the exhaust port 33 or the outflow/inflow ports 31 and 32 are provided so as to be able to communicate via the through ports 50.

As depicted in FIG. 12, when the outflow/inflow ports 31 and 32 are drilled from outside and even a slight amount of burrs is left on the cross ridgeline part 38 in a valve chamber, the seal member 53 slidably making contact with the periphery of that cross ridgeline part 38 may be impaired at the time of valve opening and closing. If making contact with a cross hole burr to be physically impaired, the seal member 53 loses a function as a seal member for direct hermetic fluid sealing. Thus, it is required to reliably remove the burr occurring on the cross ridgeline part 38.

Also, even if the burr can be removed, for example, as depicted in FIG. 11(b), when the surface width of the machined surface is nonuniform, a sliding surface between the spherical surface part 34 and the seal member 53 when the valve body 47 rotates becomes nonuniform due to an abutment location, thereby shortening the life of the seal member 53 and disabling effective seal performance. Thus, in cross hole deburring machining, finishing has to be made so that the cross ridgeline part 38 is uniform over the entire periphery.

Thus, as depicted in FIG. 10(a), if the tip part 3 of the tool main body 1 according to the present invention is used for deburring machining on the cross ridgeline part 38, as depicted in FIG. 10(b), it is possible to make finishing to obtain the machined surface 43 with a uniform surface width over the entire periphery. In the rotary valve finished as described above, the state of the slide surface of the seat member 53 can be maintained.

In this manner, since the tool main body 1 can be used for cross hole deburring machining on a workpiece with a hollow part inside a body being in a spherical shape, the tool can be used for a two-way valve, a three-way valve, a four-way valve, and so forth.

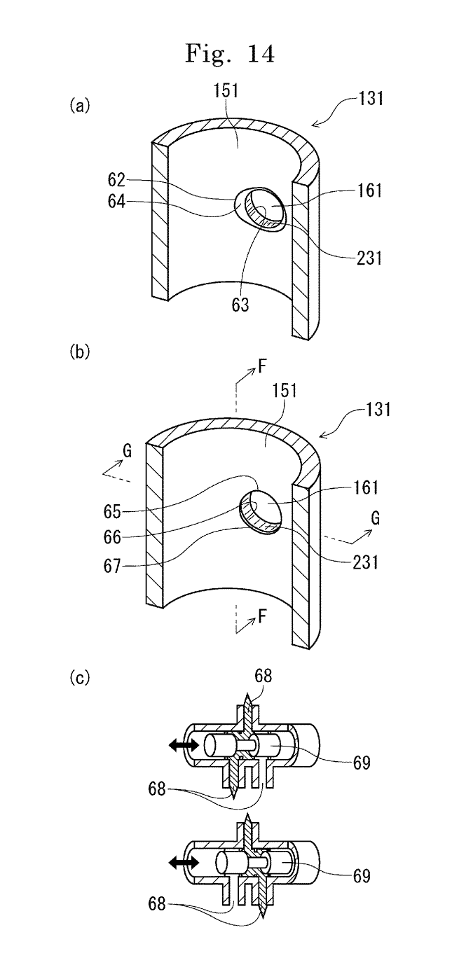

Next, another embodiment of the present invention is described based on FIG. 14. A cylindrical-surface workpiece 131 in the present example has a cylindrically-shaped hollow part 61 inside, and the inner circumferential surface of the cylindrically-shaped hollow part 61 is a cylindrical surface part 151 formed in a recessed-shaped cylindrical surface shape. For this cylindrical surface part 151, the tool main body 1 of the present invention is used.

In FIG. 14(a), 161 denotes a through path in a cylindrical shape, and its center axis is orthogonal to the center axis of the cylindrical surface part 151. A shape is depicted after a cross hole burr between this through path 161 and the cylindrical surface part 151 is subjected to rotary cutting by a spherically-shaped tip part formed in a single spherical surface shape. A crossline 62 represents a crossline with the cylindrical surface part 151 when rotary cutting is performed by the spherically-shaped tip part, and a ridgeline 63 represents a crossline with an inner surface 231 of the through path 161 when rotary cutting is performed by the spherically-shaped tip part. A surface formed between the ridgeline 62 and the ridgeline 63 is a machined surface 64 obtained by the spherically-shaped tip part. As with the machined surface 203 depicted in FIG. 8(b), this machined surface 64 has a nonuniform surface width such that the width in a longitudinal direction and the width in a lateral direction in the drawing are different.

FIG. 14(b) depicts a perspective view of the cylindrical-surface workpiece 131 when the tool main body 1 of the present invention is used to perform rotary cutting of a cross hole burr between the cylindrical-surface workpiece 131 and the through path 161. A ridgeline 65 represents a crossline with the cylindrical surface part 151 when rotary cutting is performed by the tip part 3 of the tool main body 1, and a ridgeline 66 represents a cross line with the inner surface 231 of the through path 161 when rotary cutting is performed by the tool main body 1. A surface formed between the ridgeline 65 and the ridgeline 66 is a machined surface 67 obtained by the tip part 3. As with the machined surface 204 depicted in FIG. 8(c), this machined surface 67 has a substantially uniform surface width over the entire periphery. In this manner, if the tool main body 1 according to the present invention is used for the cylindrical-surface workpiece 131, deburring machining with a substantially uniform surface width can be performed.

The eccentric distance ε of the tip part 3 of the tool main body 1 to be used for the cylindrical-surface workpiece 131 can be derived in a manner similar to that when the above-described hemispherical-surface workpiece 13.

In FIG. 14(b), an F-F section is a plane including the center axis of the cylindrical-surface workpiece 131 and the center axis of the through path 161. A G-G section is a plane including the center axis of the through path 161 and perpendicular to the F-F section. First, this F-F section is assumed to be the X′Y plane in FIG. 6(b), the deburring widths vertically in the Y-axis direction are set to be equal to each other with respect to the through path 161, and a circle of the spherically-shaped tip part with the radius S passing through the deburring points of intersections A and B with the cylindrical workpiece 131 is arranged. When the G-G section is assumed to be the XZ plane in FIG. 7(b), a lateral deburring width of the cylindrical workpiece 131 by the spherically-shaped tip part is larger than the vertical deburring width. Thus, as described above, the eccentric circle 27 passing through C′ and D′ and the point of intersection E in FIG. 7(b) is set, and a distance in the X-axis direction between the center point O′ of the spherically-shaped tip part and the center point O″ of the eccentric circle 27 is taken as the eccentric distance ε. Since this eccentric distance ε corresponds to the eccentric distance in FIG. 6(b), a bow-shaped solid of revolution formed by rotation about the eccentric axis 28 is taken as the shape of the tip part 3, thereby making it possible to obtain the tool main body 1 allowing the diagonal deburring width (minor axis and major axis) of the machined surface to be substantially uniform.

Also in the present example, the tangent angle θ between the machined surface 67 and the cylindrical surface part 151 depicted in FIG. 14 (b) is an obtuse angle, and the shape of the tip part can be adjusted so that a secondary burr is less prone to occur.

FIG. 14(c) depicts a half-transverse sectional view of a spool of an solenoid valve as an example of the cylindrical-surface workpiece 131. 68 denotes an outflow/inflow port for fluid, and 69 denotes a valve body which slides over a cylindrical inner surface in an arrow direction. The valve body 69 has a structure of sliding over the cylindrical inner surface to seal the fluid between the cylindrical inner surface and the valve body. To maintain sealability, a cross hole burr occurring to an opening in the cylindrical inner surface of the outflow/inflow port 68 is required not only to be simply removed but also to be cut so as to obtain a uniform surface width in, particularly, a sliding direction. For cross hole deburring machining on this opening of the cylindrical inner surface, the tool main body 1 according to the present invention can be applied, and machining for obtaining a uniform surface width also has an effect of increasing the life of the sliding part.

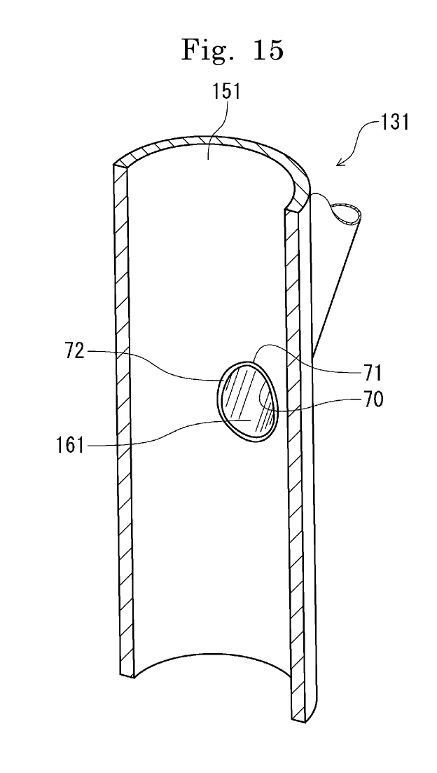

FIG. 15 depicts the cylindrical-surface workpiece 131 in which the through path 161 crosses the center axis of the cylindrical inner surface 151 as being tilted. As with FIG. 14, 70 denotes a ridgeline of a pipe passage, 71 denotes a ridgeline of the cylindrical inner surface, and 72 denotes a machined surface. The tool main body 1 according to the present invention can be applied also to this case.

Since the center axis of the through path 161 is tilted with respect to the center axis of the cylindrical inner surface, a long eccentric distance cannot be taken, compared with the orthogonal case depicted in FIG. 14. With this, although the effect of uniformization of the surface widths of the machined surface is slightly small, the surface widths can be substantially uniformized even in this case.

Furthermore, the present invention is not restricted to the description of the embodiments, and can be variously modified in a scope not deviating from the spirit of the invention described in the claims of the present invention.

### REFERENCE SIGNS LIST

1 tool main body
2 shank
3 tip part
5 cutting edge
12 groove part
13 hemispherical-surface workpiece
131 cylindrical-surface workpiece
14 spherically-shaped hollow part
61 cylindrically-shaped hollow part
15, 34 spherical surface part
151 cylindrical surface part
16, 31, 32, 161 through path (outflow/inflow port)
200, 38 cross ridgeline part
204, 43, 67, 72 surface machined by a tip part of the present invention
203, 46, 64 surface machined by a spherically-shaped tip part
29 rotary valve
30, 30′ body
47 valve body
53 seal member
100 circle (spherically-shaped tip part)
101 diameter axis
102 eccentric axis
104 minor arc
105 bow shape
ε eccentric distance
θ tangent angle
α, β visual point (arrow view)

1-6. (canceled)

7. A cross hole deburring tool which performs rotary cutting on a cross hole burr occurring on a cross ridgeline part between a through path and an inner circumferential surface of a spherically-shaped hollow part, with a center axis of the through path in a cylindrical shape not passing through a spherical center of the spherically-shaped hollow part in a workpiece and with the through path drilled into the spherically-shaped hollow part toward a direction passing through a diameter of the spherically-shaped hollow part, wherein a tool main body of this tool includes a tip part and a shank, the tip part has a shape obtained by setting a diameter axis of a circle, setting an eccentric axis parallel to the diameter axis and away therefrom by a predetermined eccentric distance, setting a closed region in a bow shape formed of a line segment obtained by cutting the eccentric axis by the circle and a minor arc on the circle by defining this line segment as a chord, setting an outer surface shape of a bow-shaped solid of revolution formed by rotating this bow shape about the eccentric axis, and taking this outer surface shape as the shape of the tip part, the tip part is configured to have an outer shape adapted to a width across corners of the cross ridgeline part, the eccentric distance is set so that a diagonal deburring width of a machined surface obtained by deburring is substantially uniform, and a surface width of the machined surface can be finished so as to be a substantially uniform width over an entire periphery.

8. The cross hole deburring tool according to claim 7, wherein a groove in an appropriate shape is formed at the tip part along a rotation axis direction of the shank, and the tip part is a double-edged blade or a triple-edged blade.

9. A cross hole deburring method using the cross hole deburring tool according to claim 7, wherein a burr occurring on the cross ridgeline part is subjected to rotary cutting by moving a position of the tip part to a predetermined position with respect to the workpiece.

10. A rotary valve obtained by drilling an outflow/inflow port in a cylindrical shape into a spherical surface part of an inner circumferential surface of a body, performing rotary cutting on a cross hole burr occurring on a cross ridgeline part between this outflow/inflow port and the inner circumferential surface of the body by the cross hole deburring tool according to claim 7, accommodating a valve body in a hemispherical body shape in this body from an opening of the body, covering this opening with a lid member, rotatably providing the valve body in the body, forming a through port in this valve body for communication with the outflow/inflow port and attaching a seal member in a circular shape, providing the outflow/inflow port so that the outflow/inflow port can be opened and closed by rotating operation of the valve body, and maintaining sealability of the seal member attached to the valve body.

11. The rotary valve according to claim 10, wherein the rotary valve is a two-way valve, a three-way valve, or a four-way valve.

12. A cross hole deburring method using the cross hole deburring tool according to claim 8, wherein a burr occurring on the cross ridgeline part is subjected to rotary cutting by moving a position of the tip part to a predetermined position with respect to the workpiece.

13. A rotary valve obtained by drilling an outflow/inflow port in a cylindrical shape into a spherical surface part of an inner circumferential surface of a body, performing rotary cutting on a cross hole burr occurring on a cross ridgeline part between this outflow/inflow port and the inner circumferential surface of the body by the cross hole deburring tool according to claim 8, accommodating a valve body in a hemispherical body shape in this body from an opening of the body, covering this opening with a lid member, rotatably providing the valve body in the body, forming a through port in this valve body for communication with the outflow/inflow port and attaching a seal member in a circular shape, providing the outflow/inflow port so that the outflow/inflow port can be opened and closed by rotating operation of the valve body, and maintaining sealability of the seal member attached to the valve body.
